(19) United States
(12) Patent Application Publication
(10) Pub. No.: US 2014/0113195 A1
(43) Pub. Date: Apr. 24, 2014

(54) NEGATIVE ELECTRODE ACTIVE MATERIAL FOR LITHIUM-ION SECONDARY BATTERIES, METHOD FOR PRODUCTION THEREOF, AND LITHIUM-ION SECONDARY BATTERY PROVIDED THEREWITH

(71) Applicant: Kazushige Kohno, Tokyo (JP)

(72) Inventor: Kazushige Kohno, Tokyo (JP)

(21) Appl. No.: 14/126,200

(22) PCT Filed: Jun. 13, 2011
(86) PCT No.: PCT/JP2011/063457

§ 371 Date: Dec. 13, 2013

(51) Int. Cl. H01M 4/525

(52) U.S. Cl. CPC H01M 4/525
USPC 429/221; 423/594.2; 252/182.1

(57) ABSTRACT

Disclosed is a negative electrode active material for lithium-ion secondary batteries which contributes to high capacity, high energy density, and safety and a lithium-ion secondary battery provided with the negative electrode active material. The negative electrode active material is an oxide containing Li and Fe and having crystalline and amorphous phases of LiFeO2 such that there is a specific ratio ranging from 13.2 to 100 between peak value of X-ray diffraction due to the plane of the crystalline phase and peak value of X-ray diffraction due to the amorphous phase. The negative electrode active material is produced by preparing a mixture of LiOH.H2O and FeOOH and heating it together with distilled water in an autoclave at 180 to 220° C. for 10 to 20 hours, thereby giving an oxide having the crystalline and amorphous phases of LiFeO2 or an oxide having the crystalline and amorphous phases of LiFeO2 and LiFe5O8.

### TECHNICAL FIELD

The present invention relates to a negative electrode active material for lithium-ion secondary batteries and a method for production thereof. The present invention relates also to a lithium-ion secondary battery provided with said negative electrode active material.

### BACKGROUND ART

Lithium-ion secondary batteries are promising future power sources for electronic machines and equipment because of their potentiality for size and weight reduction. Attempts are being made to put them into practical use with the help of a new negative electrode active material to be formed from any of graphite (either natural or artificial), carbonaceous material (typified by amorphous carbon), and alloy (composed mainly of silicon or tin).

On the other hand, lithium-ion secondary batteries for application to large-sized products such as electric vehicles are required to have a higher energy density than before, and the fulfillment of this requirement needs the development of a new material that produces a high battery capacity per unit weight. At the same time, the battery's increased energy density should be compatible with the battery's enhanced safety.

Unfortunately, conventional materials (such as carbonaceous material and alloy) suffer a disadvantage of decreasing in potential vs. Li metal to nearly 0 V when the lithium-ion secondary battery is charged. This decreased potential is liable to form dendrites of Li metal when the battery becomes deteriorated or overcharged. A noteworthy new negative electrode active material is lithium titanate (LTO) which has a potential higher than 1 V at the time of charging and does not form dendrites of Li metal.

Technical ideas for improvement in lithium-ion secondary batteries have been disclosed in the following prior art references.

Patent Document 1: A negative electrode active material whose potential vs. Li metal is higher than 1 V is used to make the dendrites of Li metal less liable to occur in charge-discharge cycles. This negative electrode active material includes oxides of lithium titanate, such as Li₄₊ₓTi₅O₁₂ (x=−1 to 3), which is of spinal structure, and Li_{2+y}Ti₃O₇ (y=−1 to 3), which is of ramsdellite structure.
Non-Patent Document 1: A negative electrode active material which contains Li₄₊ₓTi₅O₁₂ (x=−1 to 3) of spinal structure and hence permits charging and discharging at a potential vs. Li metal which is as high as 1.5 V.
Patent Document 2: A negative electrode active material composed of NaFeO₂ and graphite mixed together, which leads to a discharge capacity in excess of 372 mAh/g as the theoretical capacity of graphite. The NaFeO₂ has the lamellar sodium chloride structure like LiCoO₂ as the well-known positive electrode active material, and hence it readily permits Li to intercalate and deintercalate.
Patent Document 3: A lithium-ion secondary battery capable of charging-discharging repeatedly about 40 cycles, in which the Li salt of the electrolytic solution is a combination of LiFe₅O₈ and LiN(CF₃SO₂)₂. The former is prepared by mixing FeOOH and LiOH such that the molar ratio of Li/Fe ranges from 10/1 to 10/7, followed by sintering.

### PRIOR ART REFERENCES

### Patent Documents

Patent Document 1: JP-2010-153258-A
Patent Document 2: JP-2010-218834-A
Patent Document 3: JP-1999-025977-A

### Non-Patent Document

Non-Patent Document 1: Ceramics 45 (2010), No. 3, p. 135

### SUMMARY OF THE INVENTION

### Problems to be Solved by the Invention

A negative electrode active material needs to meet requirements for high safety as well as high capacity when it is applied to lithium-ion secondary batteries for electric vehicles. In fact, the technology disclosed in Non-Patent Document 1 is disadvantageous in that lithium titanate represented by Li₄Ti₅O₁₂ leads to a specific capacity of only about 170 mAh/g, which is lower than the theoretical value (372 mAh/g) of graphite. The technology disclosed in Patent Document 2 is undesirable to increase the capacity per unit weight because Na has a larger atomic weight than Li. The technology disclosed in Patent Document 3 should be modified such that the negative electrode active material permits repeated charging-discharging cycles even though LiN(CF₃SO₂)₂ (which is not readily available) as the Li salt of the electrolytic solution is replaced by LiPF₆ or LiBF₄ which is in common use.

It is an object of the present invention to provide a negative electrode active material for lithium-ion secondary batteries having a high capacity as well as a high energy density.

### Means for Solution to the Problems

It is an object of the present invention to provide a negative electrode active material which is an oxide containing Li and Fe and also having the crystalline and amorphous phases of LiFeO₂.

Moreover, said oxide may additionally have the crystalline and amorphous phases of LiFe₅O₈.

It is another object of the present invention to provide a method for producing a negative electrode active material for lithium-ion secondary batteries, said method comprising mixing LiOH.H₂O and FeOOH in a prescribed ratio and allowing them to react together with heating in pressurized water.

It is further another object of the present invention to provide a lithium-ion secondary battery provided with said negative electrode active material.

### Effects of the Invention

The lithium-ion secondary battery according to the present invention has a high capacity as well as a high energy density.

### BRIEF DESCRIPTION OF THE DRAWINGS

FIG. 1 is a schematic sectional view showing one example of the lithium-ion secondary battery provided with the negative electrode active material for lithium-ion secondary batteries which is defined in the present invention.

FIG. 2 is an XRD pattern of the negative electrode active material (I) synthesized in Example 1.

FIG. 3 is an XRD pattern of the negative electrode active material (II) synthesized in Example 3.

FIG. 4 is an XRD pattern of the negative electrode active material synthesized in Comparative Example 1.

FIG. 5 is an XRD pattern of the negative electrode active material synthesized in Comparative Example 2.

FIG. 6-1 is a graphical representation of the initial charge-discharge characteristics observed in the lithium-ion secondary battery prepared in Example 1.

FIG. 6-2 is a graphical representation of the initial charge-discharge characteristics observed in the lithium-ion secondary battery prepared in Example 3.

FIG. 6-3 is a graphical representation of the initial charge-discharge characteristics observed in the lithium-ion secondary battery prepared in Comparative Example 1.

FIG. 6-4 is a graphical representation of the initial charge-discharge characteristics observed in the lithium-ion secondary battery prepared in Comparative Example 2.

### MODES FOR CARRYING OUT THE INVENTION

The present invention will be described in more detail with reference to the following embodiments, which should not be construed to restrict the scope thereof.

### <Negative Electrode Active Material for Lithium-Ion Secondary Batteries>

The present invention is concerned with the negative electrode active material for lithium-ion secondary batteries which was developed based on the finding that it contributes to the battery's high capacity and high energy density if it has the crystalline and amorphous phases of LiFeO₂. It was found that such LiFeO₂ should have a specific structure such that its crystalline and amorphous phases have their respective peak values of X-ray diffraction whose ratio is within a certain range. (The peak value of the crystalline phase is one due to the (200) plane.) This will be explained later. It was also found that the negative electrode active material mentioned above may additionally have the crystalline phase of LiFe₅O₈. The LiFeO₂ and LiFe₅O₈ vary in the ratio between their crystalline and amorphous phases depending on their manufacturing process. Any desirable active material may be obtained by mixing its raw materials (LiOH.H₂O and FeOOH) in an adequate ratio.

The terms used hereunder are defined as follows:

“Amorphous phase of LiFeO₂” means amorphous phase derived from LiFeO₂;

“Amorphous phase of LiFe₅O₈” means amorphous phase derived from LiFe₅O₈; and

“Amorphous phases of LiFeO₂ and LiFe₅O₈” means amorphous phases derived from LiFeO₂ and/or LiFe₅O₈.

(1) The above-mentioned oxide represented by LiFeO₂ (referred to as the negative electrode active material (I) hereinafter) should preferably be one in which its crystalline and amorphous phases have respective peak values of X-ray diffraction whose ratio ranges from 7.6 to 100, which is calculated according to the formula (1) given later. (The peak value of the crystalline phase of LiFeO₂ is one due to the (200) plane.)

(2) The above-mentioned oxides represented by LiFeO₂ and LiFe₅O₈ (referred to as the negative electrode active material (II) hereinafter) should preferably be one in which its crystalline and amorphous phases have respective peak values of X-ray diffraction whose ratio ranges from 7.6 to 100, which is calculated according to the formula (1) given later. (The peak value of the crystalline phase of LiFeO₂ is one due to the (200) plane.)

(3) The above-mentioned oxide may be a mixture of the negative electrode active material (I) and the negative electrode active material (II).

It has been mentioned above that the conventional graphite-based material is liable to deteriorate to precipitate the dendrites of metallic lithium which cause short in the battery. This problem has been circumvented by replacing graphite with LTO (lithium titanate), which is less liable to cause precipitation of metallic lithium. Unfortunately, LTO has such a small specific capacity as to meet the requirement for high energy density.

The present invention was completed to provide a new lithium-ion second battery which has a higher capacity and energy density than before. This object was achieved by employing a new negative electrode active material which is composed mainly of LiFeO₂ having the crystalline and amorphous phases or a mixture of LiFeO₂ and LiFe₅O₈, both having the crystalline and amorphous phases. These compounds yield a larger specific capacity than graphite-based materials, and they are more noble than Li in charge potential. The present inventors found that although the battery with the negative electrode active material mentioned above has a small initial discharge capacity and a low retention rate of capacity if LiFeO₂ or a mixture of LiFeO₂ and LiFe₅O₈ has the crystalline phase only or has the amorphous phase in very small amounts, this problem is solved if the crystalline and amorphous phases exist within an adequate ratio. Incidentally, the negative electrode active material according to the present invention is unlikely to form dendrites as in the case of ordinary negative electrode active materials of lithium oxide which have a charging potential higher than 1 V and hence are less likely to form dendrites, which leads to high safety.

The formula (1) given below is used to calculate the ratio between the peak value of X-ray diffraction due to the (200) plane of the crystalline phase of LiFeO₂ and the peak value of X-ray diffraction of the amorphous phase of LiFeO₂.

Ratio between peak values=[Peak value due to the (200) plane of LiFeO₂]/[Peak value of the amorphous phase of LiFeO₂] Formula (1)

Described below is a method for calculating the ratio between peak values of X-ray diffraction specified in the present invention. Place a specimen of the negative electrode active material on the specimen mount (say, glass plate) of the X-ray diffractometer. Fix the specimen mount supporting the specimen to the X-ray diffractometer. Measure the angle of 2θ/θ by means of an ordinary wide-angle goniometer. Scrutinize the resulting diffraction pattern to determine the intensity (or value) of peaks due to diffraction by the (200) plane of the crystalline phase of LiFeO₂. Scrutinize the resulting diffraction pattern again to determine the intensity (or value) of peaks due to diffraction by the amorphous phase of LiFeO₂, said peaks appearing at the position of 2θ=16 to 26°. Insert the thus obtained peak values into the formula (1) to calculate the ratio between peak values.

### <Production of the Negative Electrode Active Materials for Lithium-Ion Secondary Batteries>

The following method is employed to produce the negative electrode active materials (I and II) for lithium-ion secondary batteries, which are defined in the present invention. The method consists of placing raw material compounds and distilled water in an autoclave and performing reaction at 180-220° C. for 10-20 hours, followed by washing, filtration, and drying.

In other words, the method is based on hydrothermal synthesis to be performed in water at high temperatures under high pressures. The hydrothermal synthesis offers an advantage of yielding a compound which is richer in amorphous components than a compound obtained by solid-phase reactions in the atmosphere under normal pressure.

The hydrothermal synthesis may be accomplished under any conditions without specific restrictions so long as it yields the negative electrode active material for lithium-ion secondary batteries pertaining to the present invention. A preferable reaction temperature is 180 to 220° C., particularly 200° C., and a preferable heating time is 10 to 20 hours.

Any commercial pressure-resistant reaction vessel may be acceptable. A Teflon®-lined one is preferable to avoid contact with raw material compounds. One made of metal (such as stainless steel) should not be used because it contaminates raw material compounds, which adversely affects the performance of the resulting lithium-ion secondary battery. The outer wall of the reaction vessel may be made of Teflon® or any metal because it does not come into contact with raw material compounds.

The reaction vessel should be one which resists internal pressures higher than 10 atm at the reaction temperature of 200° C.

The negative electrode active material (I) should be prepared from LiOH.H₂O and FeOOH mixed together in a molar ratio of 3:1 to 6:1. The negative electrode active material (II) should be prepared from LiOH.H₂O and FeOOH mixed together in a molar ratio of 1:1 to 2.5:1.

The reaction product of hydrothermal synthesis should be washed with distilled water several times, filtered off to remove washings, and dried. Drying may be usually accomplished by heating at 80° C. for 5 hours in an oven. Vacuum drying may also be acceptable.

### <Lithium-Ion Secondary Battery>

The negative electrode active material (I or II) obtained as mentioned above was used to make a sample of lithium-ion secondary battery in the following manner.

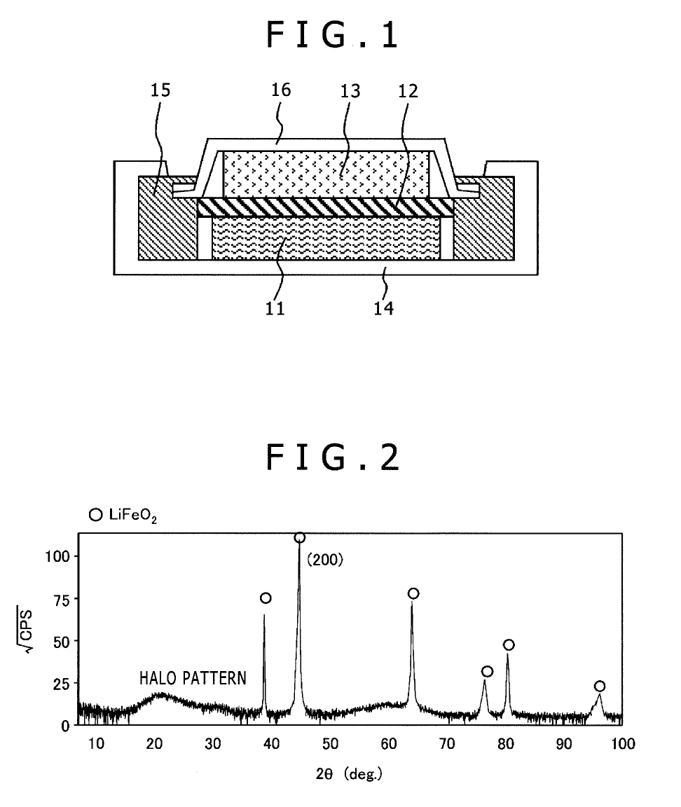

An example of the lithium-ion secondary battery is constructed as shown in FIG. 1, which is a schematic sectional view. FIG. 1 will be referenced for description of the manufacturing process.

In FIG. 1, there is shown one example of the lithium-ion secondary battery pertaining to the present invention, which has the negative electrode 13 and the counter electrode 11. The negative electrode 13 is comprised of a current collector (not shown) and a surface layer thereon (not shown) containing a negative electrode active material and a conductive assistant. The counter electrode 11 is a foil of metallic lithium.

To be more specific, the negative electrode 13 is produced by the method which consists of preparing a mixture from powdery negative electrode active material (80 wt %), carbon black (10 wt %), and binder (10 wt %), making the resulting mixture into a paste having a viscosity of 15 Pa·s by incorporation with N-methylpyrrolidone, applying the thus obtained paste onto a copper foil (which serves as a negative electrode current collector) by knife coating, followed by drying, to form a negative electrode layer, and punching out the negative electrode current collector coated with the negative electrode layer.

The negative electrode 13 (produced as mentioned above) and the counter electrode 11 (which is a metallic lithium foil) and the separator 12 interposed between them are placed in the casing 14 for a coin cell battery. Finally, the casing 14 is closed with the top cover 16, with the gasket interposed between them. Thus there is obtained the coin cell battery.

Incidentally, the coin cell battery produced as mentioned above is filled with an electrolytic solution which is a mixed solvent composed of ethylene carbonate (EC) and ethylmethyl carbonate (EMC) in a volume ratio of EC:EMC=1:2, said mixed solvent containing 1 mol of LiPF₆. The LiPF₆ may optionally be replaced by BF₄.

The invention will be described in more detail with reference to the following examples, which are not intended to restrict the scope thereof.

### EXAMPLES

### Example 1

### Synthesis of Negative Electrode Active Material (I), Production of Battery Incorporated Therewith, and Evaluation of Battery Performance

The negative electrode active material pertaining to the present invention was prepared as follows from lithium hydroxide monohydrate (LiOH.H₂O) as the Li source and iron oxyhydroxide (FeOOH) as the iron source. (The former is made by Wako Pure Chemical Industries, Ltd. and the latter is made by Kojundo Chemical Lab. Co., Ltd.) First, the two compounds as the starting materials were mixed in a molar ratio of 3:1 and placed, together with distilled water (made by Wako Pure Chemical Industries, Ltd.), in a tightly closed reaction vessel (made by SAN-AI science Co.Ltd.). Then, the reaction vessel was placed in an electric furnace and the reactants underwent hydrothermal reaction at 200° C. for 20 hours. Finally, the reaction product was washed several times with distilled water and separated from washings by filtration, followed by drying at 80° C. for 5 hours.

### <Identification of Crystalline Phase and Amorphous Phase>

The reaction product obtained as mentioned above was examined for its phase type by using a wide-angle X-ray diffractometer (Model RU200B, made by Rigaku Corporation) under the following conditions.

The apparatus is provided with an X-ray source for CuKα radiation at 50 kV and 150 mA. It is also provided with a focusing optical system having a monochromator as well as a divergent slit (1.0 deg), scattering slit (1.0 deg), and receiving slit (0.3 mm). The optical system performs scanning within the range of 5≦2θ≦100 deg at a rate of 2.0 deg/min, with the sampling intervals being 0.02 deg. The scanning axis is interlocked with the axis for adjusting the angle 2θ/θ.

All samples were identified by comparing the experimental data with ICDD (The International Centre for Diffraction Data) as the reference.

### <Calculations of Ratio Between Crystalline Phase and Amorphous Phase>

The ratio between the crystalline phase and the amorphous phase was calculated according to the formula (1) from the diffraction peak values obtained by X-ray diffractometry mentioned above. The peak values are proportional to the amounts of the crystalline and amorphous phases in the oxide, thereby higher value means larger amount of the crystalline and amorphous phase in the oxide.

### <Production of Model Battery>

Model batteries were produced in the foregoing manner. Their assembling was carried out in a box filled with argon atmosphere having a dew point under −80° C.

### <Test of Model Battery for Charge-Discharge Characteristics>

The model battery was tested for charge-discharge characteristics in a glass container made by a ground glass joint. For this test, the battery was charged and discharged repeatedly with a current density of 0.2 mA/cm² at a potential ranging from 3.0 to 0.1 V (vs. Li/Li+). The results of the test are expressed in terms of the initial capacity and the capacity (in percent) retained after 10 charge-discharge cycles. The foregoing test was carried out by using a special apparatus for evaluation of charge-discharge characteristics (Model TSCAT3000, made by Toyo System Co., LTD.).

### Example 2

### Synthesis of the Negative Electrode Active Material (I), Production of Batteries Provided Therewith, and Evaluation Of Battery Performance

The negative electrode active material (I) was prepared in the same way as in Example 1 except that the mixing molar ratio of LiOH.H₂O to FeOOH was changed to 5:1.

Also, the same procedure as in Example 1 was repeated for <Identification of crystalline phase and amorphous phase>, <Calculations of ratio between crystalline phase and amorphous phase>, <Production of model battery>, and <Test of model battery for charge-discharge characteristics>.

### Example 3

The negative electrode active material (II) was prepared in the same way as in Example 1 except that the mixing molar ratio of LiOH.H₂O to FeOOH was changed to 2.5:1.

Also, the same procedure as in Example 1 was repeated for <Identification of crystalline phase and amorphous phase>, <Calculations of ratio between crystalline phase and amorphous phase>, <Production of model battery>, and <Test of model battery for charge-discharge characteristics>.

### Comparative Example 1

### Synthesis of the Negative Electrode Active Material (LiFeO₂), Production of Batteries Provided Therewith, and Evaluation of Battery Performance

The LiFeO₂ was prepared as follows according to the process disclosed in Patent Document 1, which consists of mixing lithium carbonate (Li₂CO₃) and diiron trioxide (Fe₂O₃) in an equimolar ratio, compacting the mixture into pellets, and sintering them at 900° C. for 12 hours. (The two compounds are available from Kojundo Chemical Lab. Co., Ltd and Alpha Product, respectively).

The same procedure as in Example 1 was repeated for <Identification of crystalline phase and amorphous phase>, <Calculations of ratio between crystalline phase and amorphous phase>, <Production of model battery>, and <Test of model battery for charge-discharge characteristics>.

### Comparative Example 2

### Production of Battery in which the Negative Electrode Active Material is FeOOH and Evaluation of Battery Performance

A model battery was produced in which the negative electrode active material is iron oxyhydroxide (FeOOH) (from Kojundo Chemical Lab. Co., Ltd). The FeOOH was examined by X-ray diffractometry. The same procedure as in Example 1 was repeated for <Identification of crystalline phase and amorphous phase>, <Production of model battery>, and <Test of model battery for charge-discharge characteristics>.

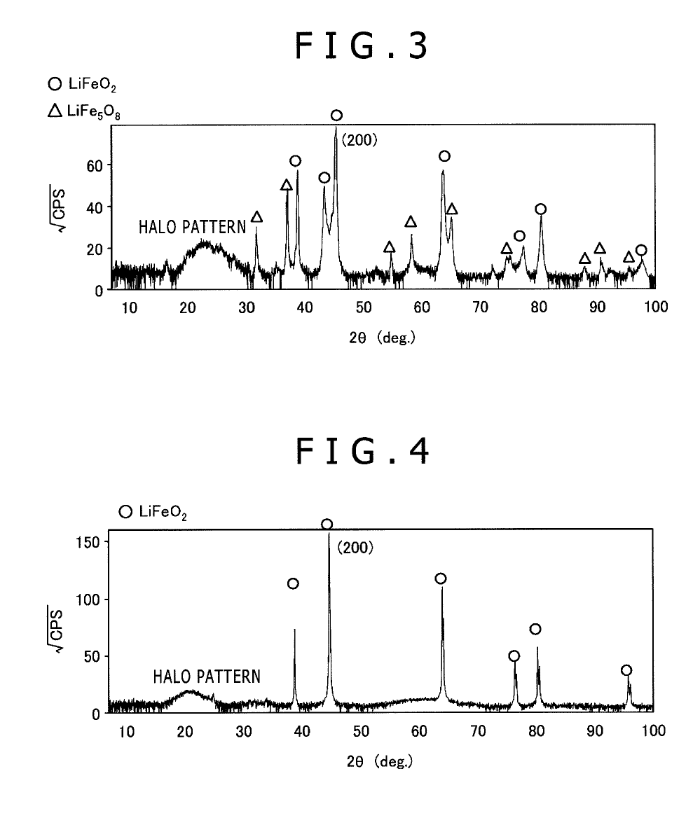

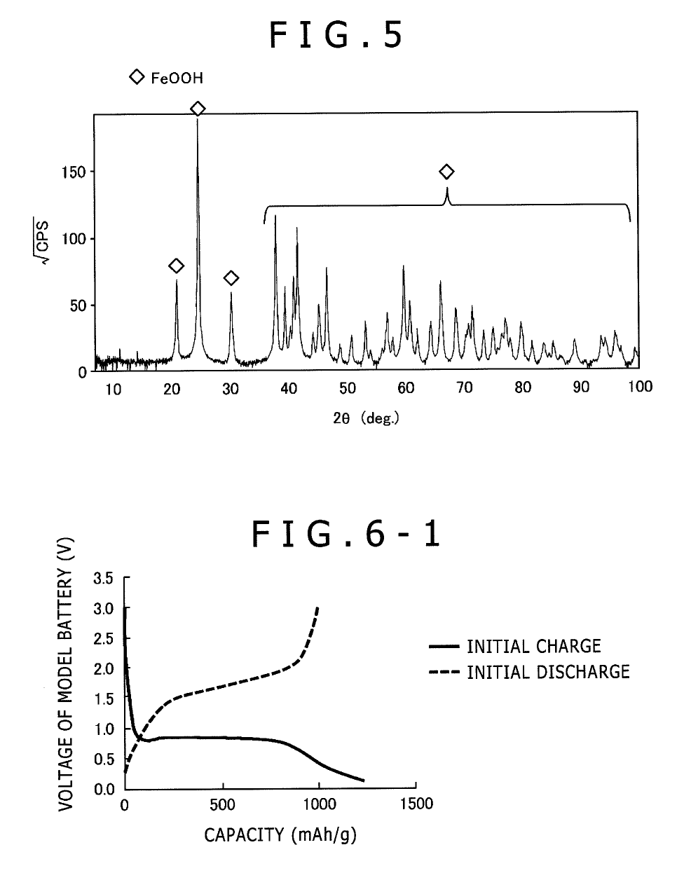

The XRD patterns obtained in Examples 1 and 3 and Comparative Examples 1 and 2 are shown in FIGS. 2 to 5, in which the ordinate represents the square root of CPS (Counts per Second) as an indication of intensity per unit time.

It is noted from FIGS. 2 to 5 that the crystalline phase of the negative electrode active material is attributable to LiFeO₂ in Example 1 and Comparative Example 1, to LiFeO₂ and LiFe₅O₈ in Example 3, and to FeOOH in Comparative Example 2.

It is also noted that each sample in Examples 1 and 3 and Comparative Example 1 gave a broad pattern (halo pattern) at 2θ=16 to 26 deg. This pattern derives from the amorphous phase of LiFeO₂ and/or LiFe₅O₈.

With the help of FIG. 2, the ratio between peak values was calculated according to the formula (1) from the square of the peak value (√CPS) attributable to the (200) plane and the square of the peak value (√CPS) attributable to the amorphous phase. The calculated value is 100. This procedure was applied to Examples 2 and 3 and Comparative Examples 1 and 2. The results are shown in Table 1.

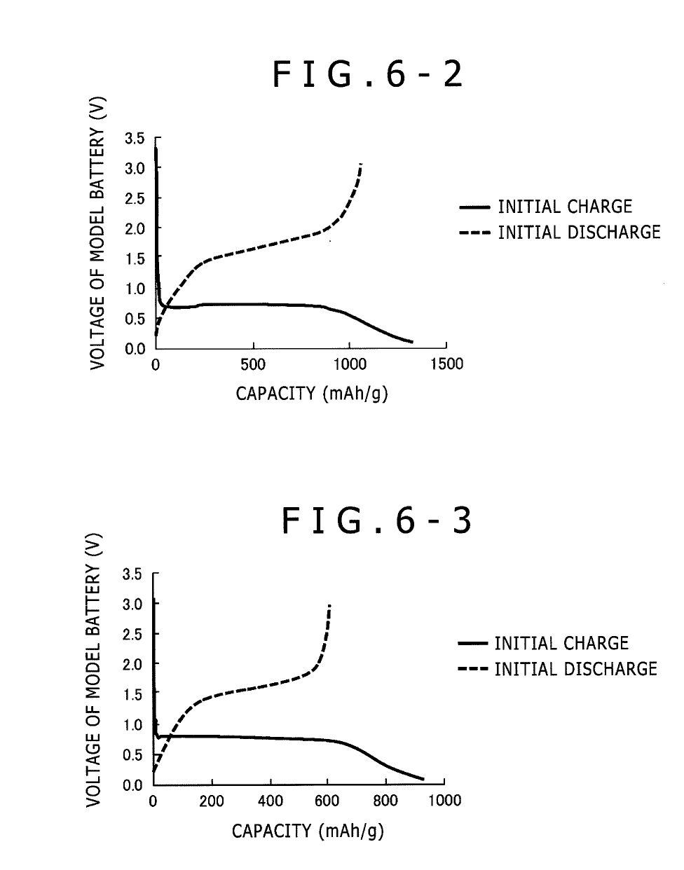

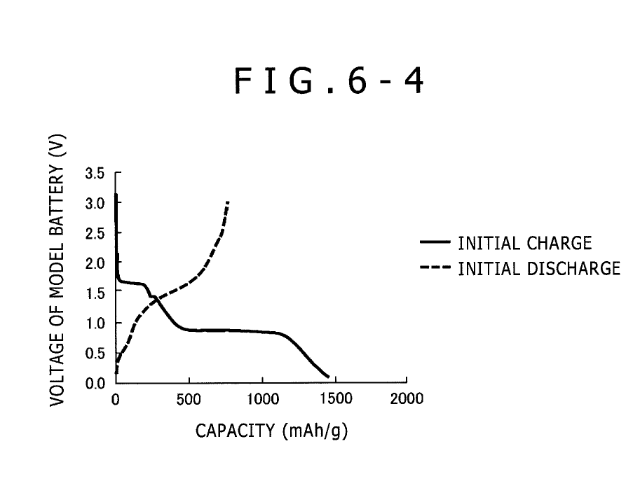

FIGS. 6-1 to 6-4 show the results of evaluation of charge-discharge characteristics of batteries in Examples 1 and 3 and Comparative Examples 1 and 2. It is noted from them that the initial discharge capacity is higher in Examples 1 and 3 than in Comparative Examples 1 and 2.

Table 1 shows the method of synthesis, the conditions of heat treatment, and the ratio between peak values in Examples 1 to 3 and Comparative Example 1. Table 2 shows the initial discharge capacity (mAh/g) and the retention (%) of capacity in Examples 1 to 3 and Comparative Examples 1 and 2.

TABLE 1

| | Method of | | | |
|---|---|---|---|---|
| Sample | synthesis | Heat treatment | Composition | Peak ratio |
| Example 1 | Hydrothermal | 200° C. × 20 h | LiFeO₂ | 100.0 |
| | method | | [Negative electrode active | |
| | | | material (I)] | |
| Example 2 | Hydrothermal | 200° C. × 20 h | LiFeO₂ | 13.2 |
| | method | | [Negative electrode active | |
| | | | material (I)] | |
| Example 3 | Hydrothermal | 200° C. × 20 h | LiFeO₂ + LeFe₅O₈ | 7.6 |
| | method | | [Negative electrode active | |
| | | | material (II)] | |
| Comparative | Solid phase | 900° C. × 12 h | LiFeO₂ | 156.3 |
| Example 1 | method | | | |

TABLE 2

| | Initial discharge | Retention of capacity |
|---|---|---|
| Sample | capacity (mAh/g) | (%) |
| Example 1 | 1061 | 89.6 |
| Example 2 | 992 | 99.0 |
| Example 3 | 1022 | 93.6 |
| Comparative Example 1 | 608 | 63.4 |
| Comparative Example 2 | — | 15.7 |

It is noted from Tables 1 and 2, which show the results in Examples 1 to 3, that the model batteries have an initial discharge capacity of 992 to 1061 mAh/g, which is higher than the theoretical capacity of graphite (800 mAh/g), in the case where the negative electrode active material (I) is LiFeO₂ or the negative electrode active material (II) is a mixture of LiFeO₂ and LiFe₅O₈ and they contain the crystalline and amorphous phases such that the ratio between their peaks ranges from 7.6 to 100.

By contrast, the results of Comparative Example 1 in Tables 1 and 2 indicate that the model battery has an initial discharge capacity of 608 mAh/g, which is lower than that in Examples 1 to 3, in the case where the negative electrode active material is LiFeO₂ which contains the crystalline and amorphous phases such that the ratio between their peaks is 156.3.

In addition, it is also noted that Examples 1 to 3 give better results than Comparative Examples 1 and 2 in the retention of capacity, which is expressed in terms of percent calculated by dividing the discharge capacity at the tenth cycle by the initial discharge capacity.

The foregoing suggests that the object of providing a lithium-ion secondary battery with a high energy density is achieved by employing the negative electrode active material for lithium-ion secondary batteries which is specified in the present invention.

The negative electrode active material for lithium-ion secondary batteries according to the present invention produces a larger capacity per weight as compared with the conventional one made of carbonaceous material or alloy. This contributes to the high energy density of batteries.

Moreover, the negative electrode active material for lithium-ion secondary batteries according to the present invention is less liable to cause lithium dendrites, owing to the lithium oxide contained therein, as compared with the conventional one made of carbonaceous material or alloy. This contributes to the high safety of batteries.

Although, in the foregoing description, LiOH.H₂O and FeOOH are assumed to be the raw materials for the negative electrode active material, they may be replaced by CH₃COOLi and Fe₂O₃, respectively. Such substitutes may undergo hydrothermal reaction in the same way as mentioned above and the reaction time may be the same as using LiOH.H₂O and FeOOH. If CH₃COOLi is to be used, molar ratio of the materials should be the same as using LiOH.H₂O and FeOOH. If Fe₂O₃ is to be used, mixing amount of Fe₂O₃ should be calculated by half of FeOOH.

### INDUSTRIAL APPLICABILITY

The negative electrode active material for lithium-ion secondary batteries according to the present invention has a larger specific capacity and is more noble in charging potential than the conventional ones based on carbonaceous material and hence it is less liable to cause lithium dendrites. Thus it is expected to find use in the field of electric source for mobile bodies and stationary energy storage, where there is a demand for large-sized lithium-ion secondary batteries superior in safety.

### EXPLANATION OF NUMERALS

11 . . . Counter electrode (Li)
12 . . . Separator
13 . . . Negative electrode
14 . . . Coin-type battery case
15 . . . Gasket
16 . . . Top cover

1. A negative electrode active material for lithium-ion secondary batteries which comprises an oxide containing lithium and iron which has the crystalline and amorphous phases of LiFeO₂, with said crystalline phase giving a peak value of X-ray diffraction due to the (200) plane and said amorphous phase giving a peak value of X-ray diffraction such that the ratio between the two peak values ranges from 7.6 to 100 which is calculated from the formula (1):
Ratio between peak values=[Peak value due to the (200) plane of LiFeO₂]/[Peak value of amorphous phase].

2. A negative electrode active material for lithium-ion secondary batteries which comprises an oxide containing lithium and iron which has the crystalline and amorphous phases of LiFeO₂ and LiFe₅O₈, with said crystalline phase giving a peak value of X-ray diffraction due to the (200) plane and said amorphous phase giving a peak value of X-ray diffraction such that the ratio between the two peak values ranges from 7.6 to 100 which is calculated from the formula (1):
Ratio between peak values=[Peak value due to the (200) plane of LiFeO₂]/[Peak value of amorphous phase].

3. A negative electrode active material for lithium-ion secondary batteries which comprises an oxide containing lithium and iron, said oxide being a mixture of an oxide having the crystalline and amorphous phases of LiFeO₂ and an oxide having the crystalline and amorphous phases of LiFeO₂ and LiFe₅O₈, with said crystalline phase giving a peak value of X-ray diffraction due to the (200) plane and said amorphous phase giving a peak value of X-ray diffraction such that the ratio between the two peak values ranges from 7.6 to 100 which is calculated from the formula (1):
Ratio between peak values=[Peak value due to the (200) plane of LiFeO₂]/[Peak value of amorphous phase].

4. A method for producing a negative electrode active material for lithium-ion secondary batteries, said method comprising preparing a mixture of (LiOH.H₂O or CH₃COOLi) and (FeOOH or Fe₂O₃) and heating said mixture together with distilled water in an autoclave at 180 to 220° C. for 10 to 20 hours, thereby providing an oxide having the crystalline and amorphous phases of LiFeO₂ or an oxide having the crystalline and amorphous phases of LiFeO₂ and LiFe₅O₈.

5. The method for producing a negative electrode active material for lithium-ion secondary batteries as set forth in claim 4, wherein said LiOH.H₂O and FeOOH are mixed in a ratio ranging from 3:1 to 6:1 or from 1:1 to 2.5:1.

6. A lithium-ion secondary battery having a positive electrode provided with a positive electrode active material, a negative electrode provided with a negative electrode active material, a separator interposed between said positive and negative electrodes, and an electrolytic solution, wherein said negative electrode active material is the negative electrode active material for lithium-ion secondary batteries which is defined in claim 1.

7. The lithium-ion secondary battery as set forth in claim 6, which has an initial discharge capacity no lower than 800 mAh/g.

8. A lithium-ion secondary battery having a positive electrode provided with a positive electrode active material, a negative electrode provided with a negative electrode active material, a separator interposed between said positive and negative electrodes, and an electrolytic solution, wherein said negative electrode active material is the negative electrode active material for lithium-ion secondary batteries which is defined in claim 2.

9. A lithium-ion secondary battery having a positive electrode provided with a positive electrode active material, a negative electrode provided with a negative electrode active material, a separator interposed between said positive and negative electrodes, and an electrolytic solution, wherein said negative electrode active material is the negative electrode active material for lithium-ion secondary batteries which is defined in claim 3.
